(19) United States
(12) Patent Application Publication
(10) Pub. No.: US 2018/0042261 A1
(43) Pub. Date: Feb. 15, 2018

(54) NEW COLOR FOR GUMS AND JELLIES

(71) Applicant: DSM IP ASSETS B.V., Heerlen (NL)

(72) Inventors: Hansjörg GRASS, Kaiseraugst (CH); Andrea HITZFELD, Kaiseraugst (CH)

(21) Appl. No.: 15/557,828

(22) PCT Filed: Mar. 24, 2016
(86) PCT No.: PCT/EP2016/056538

§ 371 Date: Sep. 13, 2017

Related U.S. Application Data
(60) Provisional application No. 62/138,675, filed on Mar. 26, 2015.

(51) Int. Cl. A23G 3/36; A23L 29/219; A23L 29/231; A23L 5/44

(52) U.S. Cl. CPC A23G 3/36; A23L 5/44; A23L 29/219; A23L 29/231; A23V 2002/00

(57) ABSTRACT

The present invention is directed to gums and jellies comprising a milled rhodoxanthin form with an average particle size D(v,0.5) of the milled rhodoxanthin in the form in the range of from 400 to 600 nm, more preferably in the range of from 500 nm to 600 nm, whereby the average particle size is measured by Laser Diffraction; Malvern Mastersizer 3000, MIE volume distribution. The present invention is also directed to such a milled rhodoxanthin form, its manufacture and its use for coloring gums (especially gummy bears) and jellies.

The present invention is directed to gums and jellies comprising a milled rhodoxanthin form, wherein the milled rhodoxanthin in the form has an average particle size D(v,0.5) of the rhodoxanthin in the range of from 400 to 650 nm, more preferably in the range of from 500 nm to 600 nm, measured by Laser Diffraction; Malvern Mastersizer 3000, MIE volume distribution. Surprisingly such gums and jellies have a color shade of rosé (diluted) to purple (concentrated) which could not be expected since rhodoxanthin itself has a red color.

Gums and jellies belong to the group of soft boiling products. These products are produced by cooking and moulding. Gums and jellies are comparatively low boiled and contain about 10-22 weight-% of moisture. The texture of these gums and jellies, which can be soft or firm, is obtained by the use of various types of water binding gelling and thickening agents such as gelatin, starch, agar-agar, pectin, and gum arabic.

Examples of gums and jellies are gum drops, jelly beans, fruit jellies and fruit-flavored slices.

Jelly confectionery can be defined as a highly concentrated mixed sugar mass that has been formed into a gel by the addition of gelatin, pectin, agar-agar or starch. The gel is mainly composed of saccharose, glucose syrup, other types of sugar (i.e. invert sugar, dextrose), gelling agent, acid, flavor and color. The gelling agents are gum arabic, gelatin, starch, agar-agar or pectin.

Two different types of products can be described:

Gums: based on gum arabic, gelatin or starch;

Jellies: based on agar-agar or pectin.

One possible differentiation of gums and jellies can be according to their physical and rheological properties:

Gums: soft and elastic/hard and little elastic/soft and very chewy/very hard;

Jelly: soft and short/soft and little elastic.

An overview of the raw materials used for the manufacture of gums and jellies and the amounts of these raw materials is given in the table 1.

Gelatin gums may e.g. prepared according to the following method:

Dissolving the gelatin in water; dissolving the sugars in water and concentrating them; mixing the gelatin solution into the cooked sugar mass after cooling; flavoring and coloring the resulting mass, whereby for coloring milled rhodoxanthin according to the present invention is used; depositing the flavored and colored mass into moulding starch at a temperature in the range of from 70 to 80° C.

If a pressure dissolver is used, the gelatin solution can be added to the sugar slurry from the beginning. The processing time is then short enough to avoid degradation of the gelatin.

An example of the composition of such gelatin gums is given in the table 2.

TABLE 2

| | Amount of ingredients |
|---|---|
| Ingredients | in weight-% |
| Water | 15 to 18 |
| gelatin | 6 to 10 |
| sucrose | 25 to 30 |
| Invert sugar | 0 to 10 |
| Glucose syrup | 40 to 50 |
| flavor | 0.1 to 0.3 |
| rhodoxanthin | 0.001 to 0.05 |
| acid | 1 to 2 |

Hard gums may e.g. prepared according to the following method:

Dissolving the gum arabic (de-aeration during some hours at 40 to 50° C.) in water; dissolving and cooking of the sugars in water; mixing the gum arabic solution into the cooked sugar mass; flavoring and coloring the resulting mass, whereby for coloring milled rhodoxanthin according to the present invention is used; depositing the flavored and colored mass into moulding starch at a temperature in the range of from 60 to 70° C.

If a pressure dissolver is used, the gum arabic solution can be added to the sugar slurry from the beginning. The processing time is then short enough to avoid degradation of the gum arabic.

An example of the composition of such hard gums is given in the table 3.

TABLE 3

| | Amount of ingredients |
|---|---|
| Ingredients | in weight-% |
| water | 10 to 13 |
| Gum arabic | 40 to 50 |
| sucrose | 30 to 40 |
| Invert sugar | 2 to 5 |
| Glucose syrup | 10 to 15 |
| Honey or licorice | 3 to 5 |
| Flavor | 0.1 to 0.3 |
| Rhodoxanthin | 0.001 to 0.05 |
| Acid | 0 to 2 |

One preferred embodiment of the present invention are gummy bears which are mostly based on gelatin.

When the color of such gummy bears is measured at the CIELAB color scale they preferably have a color value b* in the range of from 1 to 10, preferably a color value b* in the range of from 2 to 10, and a color value a* in the range of from 2 to 15, preferably a color value a* in the range of from 5 to 15.

In a preferred embodiment of the present invention the h value of the gummy bears colored with a milled rhodoxanthin form is in the range of from 10 to 25.

Preferably the milled rhodoxanthin is added to the mass to color as a dispersion. More preferably the milled rhodoxanthin in such a dispersion is encapsulated in a matrix of modified food starch. The present invention is therefore also directed to such dispersions and other forms of milled rhodoxanthin with the particle size as given above and to the manufacture of such milled forms, especially such milled dispersions.

Rhodoxanthin

Rhodoxanthin (compound of formula I) can be obtained from a natural source, by fermentation or by chemical synthesis. A natural source might be conifers, e.g. plants of Taxus baccata, or Aloe sp. (see e.g. Merzlyak et al., Photochem Photobiol Sci 2005, 4, 333-340). Chemical syntheses are e.g. described in EP-A 077 439 and EP-A 085 763.

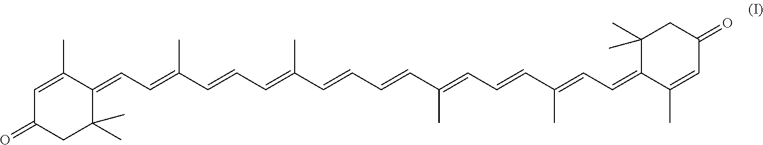 [SMILES: CC1=CC(=O)CC(C)(C)\C1=C/C=C(C)/C=C/C=C(C)/C=C/C=C/C(C)=C/C=C/C(C)=C/C=C1/C(C)=CC(=O)CC1(C)C]

The term “rhodoxanthin” used herein encompasses the (all-E)-isomer as well as mono-, oligo- or poly-(Z)-isomers. A preferred isomer mixture contains (all-E)-rhodoxanthin, (6Z)-rhodoxanthin and (6Z,6′Z)-rhodoxanthin.

Gums and Jellies

According to the present invention the milled rhodoxanthin form with the particle size as given above can be preferably used to color the following gums and jellies: wine and fruit gums, soft chewy candies, marshmellows, white turron, aerated products, tablets, dragees (gumming).

Amount of Rhodoxanthin in the Gums and Jellies

Preferably the amount of milled rhodoxanthin in the gums and jellies is in the range of from 1 to 50 ppm, based on the total weight of the gums and jellies, respectively.

Preferably the amount of milled rhodoxanthin in the gummy bears is in the range of from 2 to 20 ppm, based on the total weight of the gummy bears.

Preferably the rhodoxanthin is added to the gums (such as preferably gummy bears) and jellies as a milled dispersion. Such a milled dispersion will be described in more detail below.

Milled Rhodoxanthin Dispersion

The liquid of such a dispersion according to the present invention is water.

The average particle size D (v,0.5) of the milled rhodoxanthin in such dispersion is preferably in the range of from 400 nm to 650 nm, more preferably in the range of from 500 nm to 600 nm, measured by Laser Diffraction; Malvern Mastersizer 3000, MIE volume distribution.

When the color of such milled dispersion is measured at the CIELAB color scale (measured in TTRANS(=total transmission) mode) it has a color value b* in the range of from −7.5 to 0, preferably it has a color value b* in the range of from −2.5 to 0, more preferably it has a color value b* in the range of from −2.0 to −0.5. The color value h of such milled dispersion is preferably in the range of from 350 to 360, more preferably it is in the range of from 352 to 356, most preferably it is in the range of from 353 to 355.

In the dispersion according to the present invention the milled rhodoxanthin is preferably embedded in a matrix of a modified food starch. The amount of the milled rhodoxanthin in the dispersion is usually in the range of from 1 to 15 weight-%, based on the total weight of the dispersion. The modified food starch (esp. OSA starch) and mixtures thereof are described in more detail below. Additionally one or more water- and/or fat-soluble antioxidants may be present, preferably in an amount of from 0.5 to 5 weight-% in total, based on the total amount of the dispersion.

A preferred example of such water-soluble antioxidants is sodium ascorbate.

A preferred example of such fat-soluble antioxidants is dl-alpha-tocopherol.

Especially preferred is a dispersion where the milled rhodoxanthin is embedded in a matrix of modified food starch, whereby glycerine or a saccharide is added. An especially preferred example of such a dispersion is described in the examples.

Milled Rhodoxanthin Dispersion Comprising Milled Rhodoxanthin, Modified Food Starch, Glycerine, Water and Optionally (a) Water- and/or Fat-Soluble Antioxidant/s

When glycerine is present, the amounts of water and glycerine are preferably both in the range of from 30 to 40 weight-%, based on the total weight of the dispersion, and the amount of modified food starch is preferably in the range of from 10 to 25 weight-%, based on the total weight of the dispersion, whereby the amounts of milled rhodoxanthin, modified food starch, glycerine, water and, if present, water- and/or fat-soluble antioxidants all sum up to 100 weight-%.

Milled Rhodoxanthin Dispersion Comprising Milled Rhodoxanthin, Modified Food Starch, Water, Saccharide and Optionally (a) Water- and/or Fat-Soluble Antioxidant/s

When a saccharide is present, the amount of the saccharide is preferably in the range of from 2 to 65 weight-%, the amount of modified food starch is preferably in the range of from 15 to 45 weight-%, and the amount of water is preferably in the range of from 5 to 50 weight-%, all amounts being based on the total weight of the dispersion, whereby the amounts of milled rhodoxanthin, modified food starch, saccharide, water and, if present, water- and/or fat-soluble antioxidants all sum up to 100 weight-%.

The term “a saccharide” encompasses one saccharide or more.

The term “saccharide” in the context of the present invention encompasses mono-, di-, oligo- and polysaccharides, as well as any mixtures thereof.

Examples of monosaccharides are fructose, glucose (=dextrose), mannose, galactose, sorbose, as well as any mixtures thereof.

Preferred monosaccharides are glucose and fructose, as well as any mixture thereof.

The term “glucose” in the context of the present invention does not only mean the pure substance, but also a glucose syrup with a DE≧90. This also applies for the other monosaccharides.

The term “dextrose equivalent” (DE) denotes the degree of hydrolysis and is a measure of the amount of reducing sugar calculated as D-glucose based on dry weight; the scale is based on native starch having a DE close to 0 and glucose having a DE of 100.

Examples of disaccharides are saccharose, isomaltose, lactose, maltose and nigerose, as well as any mixture thereof.

An example of an oligosaccharide is maltodextrin.

An example of a polysaccharide is dextrin.

An example of a mixture of mono- and disaccharides is invert sugar (glucose+fructose+saccharose).

Mixtures of mono- and polysaccharides are e.g. commercially available under the tradenames Glucidex IT 47 (from Roquette Frères), Dextrose Monohydrate ST (from Roquette Frères), Sirodex 331 (from Tate a Lyle), Glucamyl F 452 (from Tate a Lyle) and Raftisweet I 50/75/35 (from Lebbe Sugar Specialties).

The most preferred saccharides are a glucose syrups or invert sugar syrups.

Other Milled Rhodoxanthin Forms According to the Present Invention

Instead of a dispersion also solid forms may be used. These can be easily produced e.g. by spray-drying the dispersion which contains a saccharide such as preferably a glucose syrup or an invert sugar syrup.

Such solid forms can then also be added to the gums and jellies during their manufacturing process.

The present invention also encompasses rhodoxanthin forms with any combination of preferred features of these forms as disclosed in this patent application though not explicitly mentioned.

“Modified Food Starch”

A modified food starch is a food starch that has been chemically modified by known methods to have a chemical structure which provides it with a hydrophilic and a lipophilic portion. Preferably the modified food starch has a long hydrocarbon chain as part of its structure (preferably C5-C18).

At least one modified food starch is preferably used to make a formulation of this invention, but it is possible to use a mixture of two or more different modified food starches in one formulation.

Starches are hydrophilic and therefore do not have emulsifying capacities. However, modified food starches are made from starches substituted by known chemical methods with hydrophobic moieties. For example starch may be treated with cyclic dicarboxylic acid anhydrides such as succinic anhydrides, substituted with a hydrocarbon chain (see 0. B. Wurzburg (editor), “Modified Starches: Properties and Uses, CRC Press, Inc. Boca Raton, Fla., 1986, and subsequent editions). A particularly preferred modified food starch of this invention has the following formula (I)

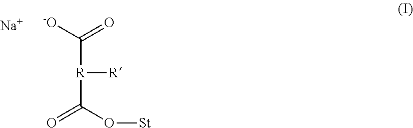

wherein St is a starch, R is an alkylene radical and R′ is a hydrophobic group. Preferably R is a lower alkylene radical such as dimethylene or trimethylene. R′ may be an alkyl or alkenyl group, preferably having 5 to 18 carbon atoms. A preferred compound of formula (I) is an “OSA-starch” (starch sodium octenyl succinate). The degree/extent of substitution, i.e. the number of esterified hydroxyl groups to the number of free non-esterified hydroxyl groups usually varies in a range of from 0.1% to 10%, preferably in a range of from 0.5% to 4%, more preferably in a range of from 3% to 4%.

The term “OSA-starch” denotes any starch (from any natural source such as corn, waxy maize, waxy corn, wheat, tapioca and potato or synthesized) that was treated with octenyl succinic anhydride (OSA). The degree/extent of substitution, i.e. the number of hydroxyl groups esterified with OSA to the number of free non-esterified hydroxyl groups usually varies in a range of from 0.1% to 10%, preferably in a range of from 0.5% to 4%, more preferably in a range of from 3% to 4%. OSA-starches are also known under the expression “modified food starch”.

The term “OSA-starches” encompasses also such starches that are commercially available e.g. from National Starch/Ingredion under the tradenames HiCap 100, Capsul, Capsul HS, Purity Gum 2000, Clear Gum Co03, UNI-PURE, HYLON VII; from National Starch/Ingredion and Roquette Freres, respectively; from CereStar under the tradename C*EmCap or from Tate a Lyle.

In an embodiment of the present invention a commercially available modified food starch such as e.g. HiCap 100 (from National Starch/Ingredion) and ClearGum Co03 (from Roquette Freres) is used.

As already stated above dispersions that contain either glycerine or a saccharide (preferably a glucose syrup or an invert sugar syrup) are preferred. Thus, their process for manufacture is now described.

Processes of the Present Invention

The present invention is also directed to a process for the manufacture of a dispersion as described above comprising the following steps:
a) Providing a dispersion comprising crystalline rhodoxanthin, modified food starch, water and glycerine or a saccharide;
b) Milling the dispersion as obtained in step a) until the milled rhodoxanthin in the dispersion has an average particle size D(v,0.5) in the range of from 400 to 650 nm, more preferably in the range of from 500 nm to 600 nm, measured by Laser Diffraction; Malvern Mastersizer 3000, MIE volume distribution.

The steps are now described in detail below.

Step a)

The amounts of the milled rhodoxanthin, modified food starch, water and glycerine or saccharide are chosen in such a way that a dispersion results with the preferred weight percentages as given above.

Step b)

The milling may be carried out with any device known to the person skilled in the art such as colloid mills and ball mills.

The same preferences as given above for the rhodoxanthin forms such as e.g. amount of rhodoxanthin, amount of modified food starch, amount of water-/fat-soluble antioxidant, amount of saccharide etc. also apply for gums and jellies.

The same preferences as given above for the gums and jellies such as their type or material etc. also apply for the gums and jellies colored with the rhodoxanthin forms of the present invention.

The present invention also encompasses any combination of any preferred feature of the rhodoxanthin form as mentioned in this patent application with any preferred feature of the gums and jellies as mentioned in this patent application though not explicitly mentioned.

The invention is now further illustrated in the following non-limiting examples.

### EXAMPLES

### Example 1: Manufacture of a Milled Rhodoxanthin Dispersion According to the Present Invention

109.1 g of modified food starch (Capsul HS) and 202.6 g of glycerine were dissolved at 60° C. in 202.6 g of water. To this solution 30 g of crystalline rhodoxanthin and 1.1 g of dl-apha-tocopherol were added.

The resulting coarse aqueous rhodoxanthin dispersion has then been milled by passing it continuously through the milling chamber of the Dispermate SL 603 agitated ball mill until the desired particle size (approx. 600 nm (average value)) has been achieved (“so called wet milling process”). The physical properties of the resulting rhodoxanthin dispersion are listed in the following:

Content of milled rhodoxanthin in the dispersion determined by HPLC=5.4%

Content of milled rhodoxanthin in the dispersion determined by UV=5.1%

E1/1_{corr}. in H₂O (λₘₐₓ)=400 (498 nm)

The color intensity E1/1 is the absorbance of a 1% solution and a thickness of 1 cm and is calculated as follows: E1/1=(Amax-A650)*dilution factor/(weight of sample*content of product form in %).

“(Amax-A650)” means the value you get when you subtract the Adsorption value measured at 650 nm (“A650”) wavelength from the value (“Amax”) that was measured at the maximum Adsorption in the UV-Spectrophotometer.

“*” means “multiplied with”.

“dilution factor”=the factor by which the solution has been diluted.

“weight of sample”=the amount/weight of the formulation that was used in [g]

“content of product form in %”=“the amount of milled rhodoxanthin in the dispersion in %” which is 5.1 in the present case.

Color Values:

Measured as 5 ppm dispersion in H₂O (1 cm, TTRAN): L*/a*/b*=76/13/−1.3; L*/C*/h=76/13/354.

Measured as 10 ppm dispersion in H₂O (1 cm, TTRAN): L*/a*/b*=59/21/−2.1; L*/C*/h=59/21/354.

Color Measurement

The color (lightness, Chroma, and hue) of the gummy bears is determined with a HunterLab Ultra Scan Pro spectrocolorimeter (Hunter Associates Laboratory, Reston, Va., USA) and expressed on basis of the CIELAB color scale. The mode used was RSIN which stands for Reflectance—Specular Included. The small area view (SAV) with a diameter of 4.826 mm (0.190 inch) was chosen. Color measurements are carried out after CIE guidelines (Commission International d'Eclairage). Values can be expressed as planar coordinates as L*, a*, b* with L* being the measuring values for lightness, with a* being the value on the red-green axes and b* being the value on the yellow-blue axes.

The Chroma (C*) sometimes called saturation describes the vividness or dullness of a color which can be calculated as followed:

C*=√(a*2+b*2)

The angle called hue (h) describes how we perceive an object's color and can be calculated as followed:

h=tan(b/a)(−1)

For measuring the color values the gummy bears are fixed in front of the orifice of the spectrocolorimeter and a white background is used during the measurement.

Gummy bears based on a gelatin matrix are traditionally products deposited in starch moulds in order to loose moisture in the starch bed.

The softness of the gummy can be modulated by the concentration of the gelatin used in the recipe of the matrix (5-10 weight-%).

They can be prepared using different colors, product forms and concentrations. Gummy bears are prepared according to the process as given below with the following composition:

| Ingredients (for approximately 1 kg of gummy bears) | [g] |
|---|---|
| Gelatine bloom 200-260 | 80.0 |
| Water 1 | 125.0 |
| Sugar | 290.0 |
| Water 2 | 120.0 |
| Glucose syrup DE 38 | 390.0 |
| Citric acid, powdered | 10.0 |
| Strawberry flavor | 0.2 |
| Rhodoxanthin stock solution ⋄ | 2-20 g* |

*Concentration depends on the desired color shade
⋄ A rhodoxanthin stock solution is prepared by mixing 2 g of the rhodoxanthin dispersion prepared according to example 2 and 48 g of demineralized water and, thus, dispersing the rhodoxanthin in water resulting in the so-called “rhodoxanthin stock solution”.

Process:

80.0 g of gelatin (bloom 200-260) is mixed with 125.0 g of cold water. The gelatin is then dissolved in the water in a water bath of 60° C. resulting in a gelatin solution. 290 g of sugar are dissolved in 120.0 g of water by heating. 390.0 g of a glucose syrup with a DE of 38 are added to the sugar solution and gently stirred resulting in a sugar/glucose syrup solution. Afterwards the gelatin solution is added to the sugar/glucose syrup solution and gently stirred. 10.0 g of powdered citric acid are added and stirred until the citric acid is dissolved completely. 2 to 20 g (depending on the desired color shade) of the rhodoxanthin stock solution and 0.2 g of a commercially available strawberry flavor are added subsequently while stirring gently. It should be taken care that no air is entrapped in the mass. Thus, if possible a vacuum cooker should be used. The resulting mass is then filled in a filling hopper and poured in starch printed moulds and are let solidify for at least 48 hours at room temperature. The resulting gummy bears are then demoulded, the starch is removed and the gummy bears are polished with a suitable oil or wax and packaged in airtight bags. Final water content of the gummies is around 20%.

| | L* | a* | b* | L* | C* | h |
|---|---|---|---|---|---|---|
| 5 ppm | | | | | | |
| initial | 37.98 | 10.18 | 4.38 | 37.98 | 11.08 | 23.26 |
| 10 ppm | | | | | | |
| initial | 32.07 | 11.42 | 2.72 | 32.07 | 11.74 | 13.42 |
| 20 ppm | | | | | | |
| initial | 29.93 | 10.38 | 2.48 | 29.93 | 10.67 | 13.44 |

Each value given is an average value of 10 individual measurements

The table below shows the short term color stability data over 3 weeks stored under white light, 800 lux, 12 hours per day during 3 weeks for 3 different concentrations. Each value is an average out of 10 individuals. The DE* value is calculated as follows:

DE*=\sqrt{(ΔL)²+(Δa)²+(Δb)²}

The DE* is hardly visible for human eyes if the value is <3. This is the case for all 3 different concentrations.

| | L* | a* | b* | C* | h | DE* |
|---|---|---|---|---|---|---|
| 5 ppm | | | | | | |
| initial | 37.98 | 10.18 | 4.38 | 11.08 | 23.26 | |
| 2 weeks | 37.41 | 9.11 | 6.42 | 11.15 | 35.09 | 2.37 |
| 3 weeks | 37.12 | 8.75 | 6.68 | 11.01 | 37.32 | 2.84 |
| 10 ppm | | | | | | |
| initial | 32.07 | 11.42 | 2.72 | 11.74 | 13.42 | |
| 1 week | 30.90 | 10.65 | 3.37 | 11.17 | 17.61 | 1.54 |
| 2 weeks | 30.54 | 9.81 | 3.66 | 10.47 | 20.53 | 2.41 |
| 3 weeks | 30.15 | 9.61 | 3.91 | 10.38 | 22.19 | 2.90 |
| 20 ppm | | | | | | |
| initial | 29.93 | 10.38 | 2.48 | 10.67 | 13.44 | |
| 1 week | 29.07 | 9.26 | 2.99 | 9.73 | 17.92 | 1.51 |
| 2 weeks | 28.86 | 8.78 | 3.17 | 9.34 | 19.84 | 2.04 |
| 3 weeks | 28.72 | 8.70 | 3.31 | 9.31 | 20.87 | 2.23 |

TABLE 1

| Raw | Jellies | | | Gums of | Gum arabic gums | | Starch gums | |
|---|---|---|---|---|---|---|---|---|
| materials | Pectin | Agar-agar | starch | gelatin | soft | hard | soft | hard |
| Balance | 70/30 to | 70/30 to | 60/40 to | 60/40 to | 65/45 to | 70/30 to | 60/40 to | 70/30 to |
| sucrose- | 60/40 | 60/40 | 45-55 | 40/60 | 50/50 | 65/35 | 45/55 | 45/55 |
| glucose | | | | | | | | |
| syrup | | | | | | | | |
| Pectin | 1.2 to 2.0% | | | | | | | |
| Agar-agar | | 0.8 to 1.2% | | | | | | |
| Thin boiling | | | 11 to 15% | | | | | |
| starch | | | | | | | | |
| gelatin | | | | 5 to 10% | 2 to 3% | | 2 to 3% | |
| Gum arabic | | | | | 25 to 35% | 40 to 55% | | |
| Waxy maize | | | | | | | 20 to 30% | 25 to 35% |
| starch | | | | | | | | |
| Residual | 20 to 22% | 20 to 22% | 15 to 20% | 15 to 20% | 15 to 17% | 10 to 13% | 15 to 17% | 10 to 13% |
| moisture | | | | | | | | |
| combinations | gelatin | gelatin | gelatin | Gum arabic | | Starch | | Gelatin |
| | | | | Pectin | | | | Gum arabic |
| | | | | Agar-agar | | | | |
| | | | | Starch | | | | |

1. A gum or a jelly comprising a milled rhodoxanthin form with an average particle size D(v,0.5) of the milled rhodoxanthin in the form in the range of from 400 to 600 nm, more preferably in the range of from 500 nm to 600 nm, whereby the average particle size is measured by Laser Diffraction; Malvern Mastersizer 3000, MIE volume distribution.

2. The gum or jelly according to claim 1, wherein the amount of the milled rhodoxanthin is in the range of from 1 to 50 ppm, based on the total weight of the gum or jelly.

3. The gum according to claim 1 being a gummy bear.

4. The gummy bear according to claim 3 having a color value b* in the range of from 1 to 10 (preferably 2 to 10) at the CIELAB color scale and a color value a* in the range of from 2 to 15 (preferably 5 to 15) at the CIELAB color scale.

5. The gummy bear according to claim 3, wherein the amount of the milled rhodoxanthin is in the range of from 2 to 20 ppm, based on the total weight of the gummy bear.

6. The gum or the jelly according to claim 1, wherein the milled rhodoxanthin is added to the gum or jelly as a dispersion wherein the milled rhodoxanthin is encapsulated in a matrix of modified food starch.

7. A form comprising milled rhodoxanthin, wherein the milled rhodoxanthin in the form has an average particle size in the range of from 400 to 650 nm, more preferably in the range of from 500 nm to 600 nm, measured by Laser Diffraction; Malvern Mastersizer 3000, MIE volume distribution.

8. The form according to claim 7 being a dispersion.

9. The form according to claim 7, wherein the rhodoxanthin is encapsulated in a matrix of modified food starch.

10. The form according to claim 9, further comprising either glycerine or a saccharide.

11. A process for the manufacture of a dispersion according to claim 8 comprising the following steps:
a) Providing a dispersion comprising crystalline rhodoxanthin, modified food starch, water and glycerine or a saccharide;
b) Milling the dispersion as obtained in step a) until the milled rhodoxanthin in the dispersion has an average particle size D(v,0.5) in the range of from 400 to 650 nm, more preferably in the range of from 500 nm to 600 nm, measured by Laser Diffraction; Malvern Mastersizer 3000, MIE volume distribution.

12. Use of a milled rhodoxanthin form with an average particle size D(v,0.5) of the milled rhodoxanthin in the form in the range of from 400 to 600 nm, more preferably in the range of from 500 nm to 600 nm, whereby the average particle size is measured by Laser Diffraction; Malvern Mastersizer 3000, MIE volume distribution, for coloring gums and jellies.

13. The use according to claim 12, wherein the milled rhodoxanthin form is a dispersion, wherein the rhodoxanthin is encapsulated in a matrix of modified food starch, and wherein the dispersion further comprises either glycerine or a saccharide.

14. A method for coloring gums or jellies, wherein a milled rhodoxanthin form with an average particle size D(v,0.5) of the milled rhodoxanthin in the form in the range of from 400 to 600 nm, more preferably in the range of from 500 nm to 600 nm, whereby the average particle size is measured by Laser Diffraction; Malvern Mastersizer 3000, MIE volume distribution, is used to impart the color to the gums or jellies.

15. A process for the manufacture of gummy bears comprising the step of adding a milled rhodoxanthin form according to claim 7 as coloring agent during the manufacturing process.
